(19) United States
(12) Patent Application Publication
(10) Pub. No.: US 2015/0286607 A1
(43) Pub. Date: Oct. 8, 2015

(54) DETERMINATION OF THE STATE OF AN I2C BUS

(71) Applicant: Robert Bosch GmbH, Stuttgart (DE)

(72) Inventors: Dorde CVEJANOVIC, Muenchen (DE); Jan HAYEK, Muenchen (DE)

(21) Appl. No.: 14/669,852

(22) Filed: Mar. 26, 2015

(30) Foreign Application Priority Data
Apr. 8, 2014 (DE) 10 2014 206 752.9

(51) Int. Cl. G06F 13/42; G06F 11/30; G06F 13/364

(52) U.S. Cl. CPC G06F 13/4291; G06F 13/364; G06F 13/4282; G06F 11/3027; G06F 11/3048

(57) ABSTRACT

A method for determining a bus state of an I2C bus having a first line SCL and a second line SDA, includes predetermined states and predetermined transitions between the states. Conditions for levels or transitions on the lines SCL and SDA are assigned to the transitions. The method is exactly in a predetermined state SP when the bus is not allocated and neither a legal nor an illegal transfer occurs on the bus.

### RELATED APPLICATION INFORMATION

The present application claims priority to and the benefit of German patent application no. 10 2014 206 752.9, which was filed in Germany on Apr. 8, 2014, the disclosure of which is incorporated herein by reference.

### FIELD OF THE INVENTION

The present invention relates to the determination of a state of an I2C-bus. In particular, the present invention relates to the fail-safe determination of when a transfer in conformity with the protocol occurs on the bus and when it does not.

BACKGROUND INFORMATION

The I2C bus is a two wire bus which is also known as TWI (two wire interface). The I2C includes a data line SDA and a clock line SCL for transferring information between two devices. Two or multiple devices may be connected to the I2C bus, one device (master) controlling the bus and the other devices (slaves) being able to be controlled via the bus. The master may, for example, include a microcomputer, while the slaves include sensors or input devices.

An electronic entertainment device, for example, a mobile phone, a smart phone or a game console, includes an I2C bus having at least one slave. The slave listens on the I2C bus to determine a data transmission. The data transmission includes a start signal, a number of transferred bits and a stop signal. If the I2C bus is not assigned, no transmission takes place.

To signal certain states, for example, to prompt a connected slave to be reset, the SDA and SCL lines may be controlled by the master in such a way that a bus state arises which is not defined or is illegal according to the applicable protocol. In such a state, a start condition may not be erroneously detected by a slave.

Patent document U.S. Pat. No. 6,530,029 B1 relates to a circuit for determining a state of an I2C bus. If the I2C bus passes through a sequence of non-standard-compliant states, the shown circuit may enter a state in which a determination of the bus state is no longer possible. The circuit must then be reset by an external device.

Patent document EP 1 607 864 A2 relates to a time-controlled monitoring circuit (“watchdog”) for carrying out such an external reset. However, a transfer on the I2C bus may remain unnoticed. It is also not ensured in every case that an error state is correctly detected.

Patent document GB 2 313 987 A1 relates to another circuit proposal, which requires that the signals of the I2C bus are sampled at a frequency higher than the highest frequency occurring on the bus.

### SUMMARY OF THE INVENTION

An object of the present invention is to provide a method for determining the bus state of an I2C bus, which overcomes at least several of the above-mentioned disadvantages. The present invention achieves this objective using a method and an evaluation circuit having the features of the independent claims. Subclaims describe specific embodiments.

A method according to the present invention for determining a bus state of an I2C bus having a first line SDA and a second line SCL includes the following states: a first state SP, which is assigned to a non-allocated I2C bus, a second state D3, which is assigned to an illegal state, and a third state D5 and a fourth state D4, which are each assigned to a legal transfer. Furthermore, the following transitions between the states are defined: from D4 to D5, if SCL=0 and SDA has a rising edge, from D4 to D5, if SCL=0 and SDA has a falling edge, from SP to D5, if SDA=0 and SCL has a falling edge, from D5 to SP, if SCL=1 and SDA has a rising edge, from D4 to SP, if SCL=1 and SDA has a falling edge, from D3 to SP, if SCL=1 and SDA=1, and from SP to D3, if SDA=1 and SCL has a falling edge.

The described method makes it possible to carry out the determination of the bus state asynchronously, i.e., without using a clock signal outside the bus signals. The system of states and transitions is completed, a transition occurring exactly at the time, when the conditions assigned to it are all met. In all other circumstances, no transition occurs. As a result, the method is always in one of the four states and a deadlock or a freeze of the method is inherently impossible. The method may therefore be reliably used on all sequences of levels or transitions on the lines SDA and SCL and may always correctly reflect the bus state.

The described method uses neither a higher sampling frequency (oversampling) compared to a bus frequency, nor a time-controlled monitoring circuit. The state of the I2C bus may thus be determined faster or more reliably than according to the known proposals of the related art.

A start signal of a data transmission on the I2C bus may be determined based on levels or transitions on the SCL and SDA lines only when a transition takes place from first state SP into third state D5.

In this way, the method may be used to control when a protocol-compliant transfer takes place on the bus and when it does not. This may prevent non-protocol-compliant transfers from being erroneously interpreted and the system from being transferred into an undefined state.

An evaluation circuit according to the present invention for determining a bus state of an I2C bus includes three RS flip-flops a, b and c. Using levels of the outputs of RS flip-flops a, b and c, a binary word is coded, which is assigned to the states of the described method as follows: SP corresponds to 101, D5 corresponds to 001, D4 corresponds to 000 and D3 corresponds to 111. In one general specific embodiment, the Hamming distance of the code words of all states, which are interconnected in pairs by state transitions, may be equal to 1.

Furthermore, a combinational circuit is provided for forming the described transitions.

The RS flip-flops may be operated asynchronously, making it possible to achieve a fast and reliable implementation of the described method. The combinational circuit may include a number of logic gates, which implements the described transitions. The gates and flip-flops form a manageable number of digital logic elements, with the aid of which the determination of the bus state may be carried out. The circuit may be easily integrated into a different circuit. For example, a sensor for connection to an I2C bus may include a bus interface, in which the described evaluation circuit is used. This may improve the operation of the sensor on the I2C-bus, even if non-standard-compliant signals are transmitted via the I2C bus.

An inverting output of first RS flip-flop a may be led out to provide a rising edge when a start signal has been detected.

The output may also provide a falling edge, when a stop state or a repeated start state has been detected. If the output maintains a low level (LOW, logical 0), this may indicate that the bus is idle or that an illegal state is present. A high level (HIGH, logical 1) at the output may represent a legal data transfer occurring on the bus. A non-inverting output of first RS flip-flop a may be led out alternatively or in addition, to indicate the same situations using inverted levels or edges.

A circuit for the interpretation of the signals of the I2C bus, and in particular for the evaluation of transmitted data, may thus be easily enabled or disabled, so that the detection performance or operating reliability of the circuit may be increased.

In one specific embodiment, the circuit for determining a protocol-compliant transfer of the start signal is carried out using the described evaluation circuit in an integrated manner.

The present invention is now described in greater detail with reference to the appended drawings.

### BRIEF DESCRIPTION OF THE DRAWINGS

FIG. 1 shows a system having an I2C bus including multiple devices.

FIG. 2 shows a state graph having state transitions of a method for determining a bus state of the I2C bus of FIG. 1.

FIG. 3 shows an expanded state graph based on the state graph of FIG. 2.

FIG. 4 shows a circuit diagram of an evaluation circuit for determining the bus state of the I2C bus of FIG. 1.

### DETAILED DESCRIPTION

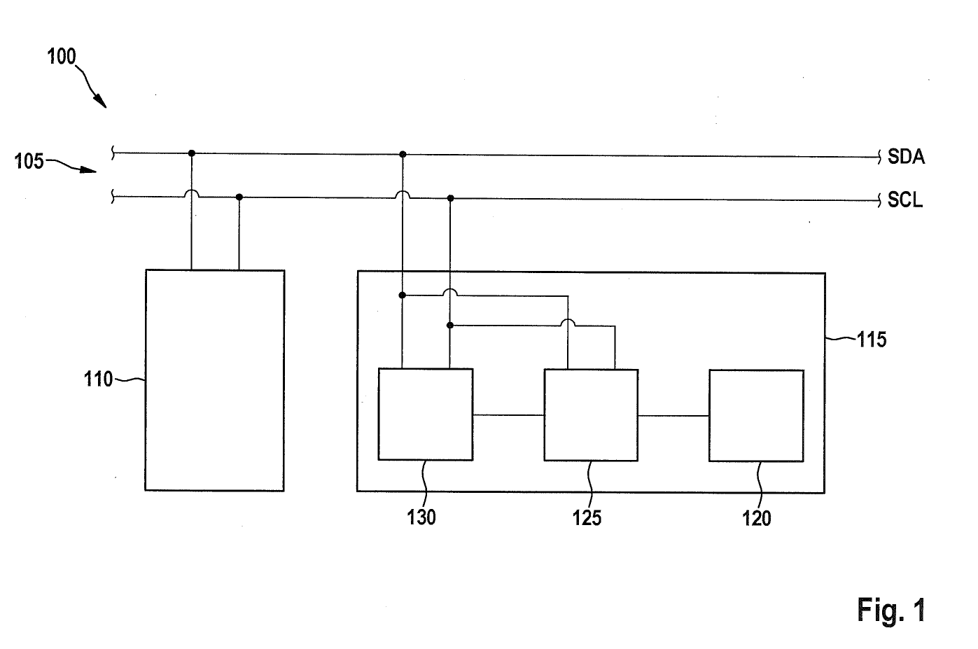

FIG. 1 shows a system 100 including an I2C bus 105, to which two devices are connected, for example. In the present example, a first device 110 (master) is configured for bus control, while a second device 115 (slave) may be controlled via I2C bus 105. I2C bus 105 includes two lines, which are commonly referred to as data line SDA and clock line SCL. Each device 110, 115 is connected to both lines.

System 100 may be used, for example, within an electronic entertainment device. In the present exemplary specific embodiment, second device 115 is configured as a sensor module. For this purpose, second device 115 includes a sensor 120 for sampling a physical quantity, for example, a rotation rate or an acceleration, a bus interface 125 for transmitting a measured value of sensor 120 via I2C bus 105, and an evaluation circuit 130 for determining a bus state of I2C bus 105. Bus interface 125 and evaluation circuit 130 are each connected to lines SDA and SCL of I2C bus 105. Bus interface 125 is configured for detecting and evaluating a transfer on I2C bus 105. Bus interface 125 may also be configured for transmitting data via I2C bus 105. Evaluation circuit 130 is configured for preventing the evaluation of bus interface 125 when I2C bus 105 is not in a state from which a specification-compliant data transmission may be started. Evaluation circuit 130 may be configured to be asynchronous and requires no clock signal for sampling levels or transitions of lines SDA and SCL.

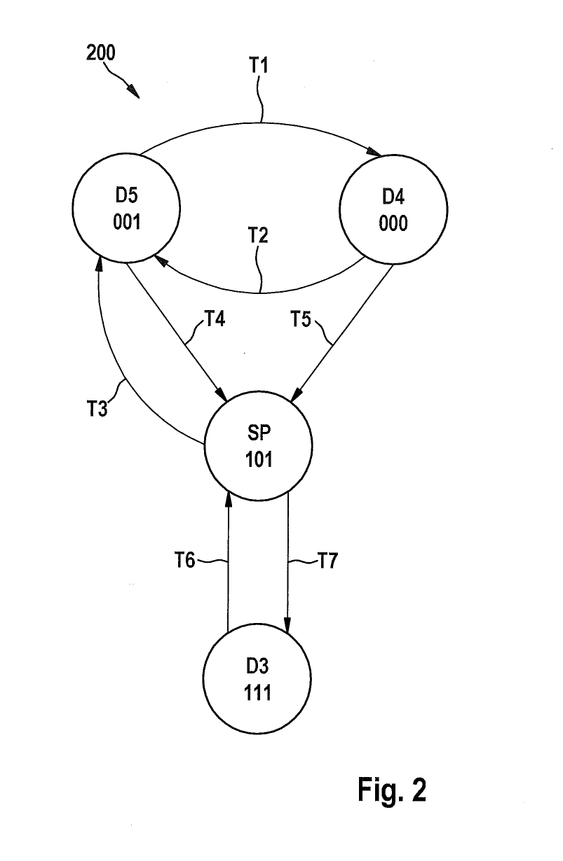

FIG. 2 shows a method 200 for determining a bus state of I2C bus 105 of FIG. 1. Method 200 is represented as a state graph having state transitions.

Circles represent states, states D3, D4, D5, and SP being provided. Arrows between the circles represent transitions, transitions T1 through T7 being provided. Method 200 is always in one of the provided states. State SP is assumed when I2C bus 105 is not allocated; one of states D4 and D5 is assumed while a legal data transfer occurs on I2C bus 105, and state D3 is assumed when a non-specification-compliant transfer is processed on I2C bus 105.

Transitions between states D3 through D5 and SP occur when a condition which is assigned to a transition T1 through T7, which leads from the first to the second state, is met. The conditions refer always to signals on lines SDA and SCL. The following transitions are defined:

Transition T1 from D5 to D4 if SCL=0 and SDA=rising edge;

Transition T2 from D4 to D5 if SCL=0 and SDA=falling edge;

Transition T3 from SP to D5 if SDA=0 and SCL=falling edge;

Transition T4 from D5 to SP if SCL=1 and SDA=rising edge;

Transition T5 from D4 to SP if SCL=1 and SDA=falling edge;

Transition T6 from D3 to SP if SCL=1 and SDA=1; and

Transition T7 from SP to D3 if SDA=1 and SCL=falling edge;

Transition T6 may actually be triggered by one of two alternative conditions. According to the first condition, SCL=1 and SDA=rising edge and according to the second condition, SDA=1 and SCL=rising edge. The Boolean OR combination of these conditions provides the above-mentioned condition for transition T6.

The start state is present when transition T3 occurs. If the stop state or a repeated stop state is present, transition T3 occurs. States D5 and D4 and transitions T1 and T2 occurring between them denote a legal data transfer on I2C bus 105. States SP and D3 as well as transitions T6 and T7 occurring between them represent an idle I2C bus 105 or an illegal state. The stop state on I2C bus 105 is present when transition T4 occurs.

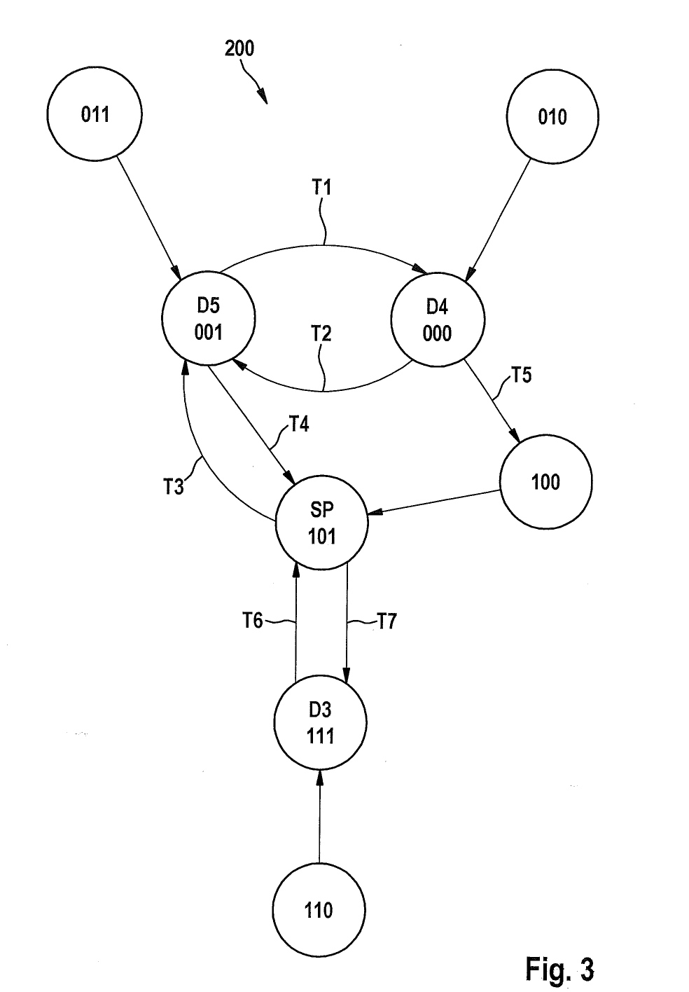

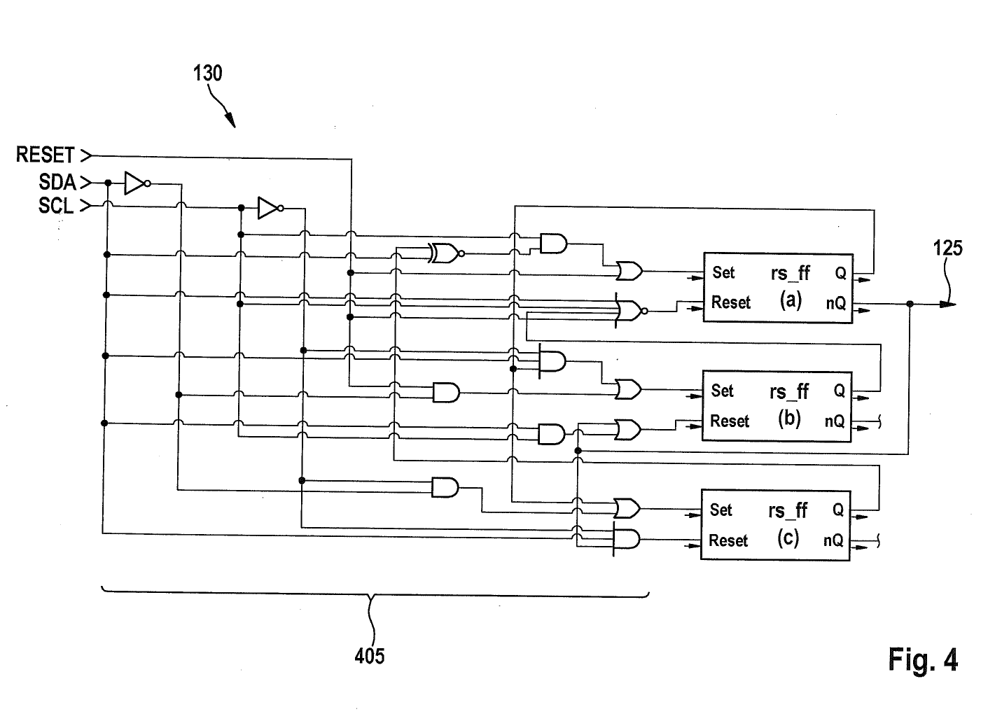

FIG. 3 shows an expanded state graph of method 200 based on the state graph of FIG. 2. As described in greater detail below with reference to FIG. 4, method 200 may be implemented with the aid of an evaluation circuit 130 which includes three RS flip-flops for the storage of states. Accordingly, a total of eight states of evaluation circuit 130 are possible. A three-digit binary word, which is made up of the levels of the non-inverted outputs of the RS flip-flop, is bijectively assigned to each state. If RS flip-flops a, b and c are named, the output of RS flip-flop a determines the most significant bit and the output of RS flip-flop c determines the least significant bit of the binary word. In the states of FIGS. 2 and 3, the resulting binary words are each registered in the states.

Compared to the state graph of FIG. 2, further transitions which are not subject to any conditions and bear no label were added. States which are only able to pass through such a spontaneous transition into another state are also not named.

Moreover, the transition from state D4 into state SP is divided into two discrete transitions in order to correctly modulate that the states of multiple RS flip-flops are not able to change simultaneously during a single transition.

The nameless, unstable states are also necessary to ensure that for evaluation circuit 130, a transition into stable states is possible from all states, which, for example, may be assumed on a random basis after the switch-on, from which a transition may only occur if a predetermined condition is met.

FIG. 4 shows a circuit diagram of a possible implementation of evaluation circuit 130 based on state graph 200 of one of FIG. 2 or 3. Evaluation circuit 130 includes a first RS flip-flop a, a second RS flip-flop b and a third RS flip-flop c. In addition, a combinational circuit 405 is provided which includes a number of logic gates in order to, based on signals on lines SDA and SCL as well as outputs of flip-flops a, b and c, provide signals to the set or reset inputs of RS flip-flops a, b and c, which implement transitions T1 through T7 and the unnamed, unconditional transitions from FIG. 3.

An optional part of combinational circuit 405 is provided for switching evaluation circuit 130 into a defined initial state prompted by an external RESET signal. In the present specific embodiment, this state is dependent on clock line SCL. If the RESET signal occurs while SCL has a high level, evaluation circuit 130 passes into state SP, otherwise it passes into state D3.

An inverting output nQ of first RS flip-flop a is led out. Output nQ provides a rising edge exactly when a start signal has been detected. Output nQ further provides a falling edge when a stop state or a repeated start state has been detected. If the output maintains a low level (LOW, logical 0), this indicates that the bus is idle or that an illegal state is present. A high level (HIGH, logical 1) at output nQ indicates a legal data transfer occurring on the bus.

Another specific embodiment of evaluation circuit 130 according to the state graph of FIG. 2, but omitting transition T5, requires only the two RS flip-flops a and b. The following assignment may then apply between the binary words formed from the outputs of the RS flip-flops and states of evaluation circuit 130: D4: 00; D5: 01; D3: 10 and SP: 11. In this specific embodiment, no pulse is provided on the non-inverting output of first RS flip-flop b, if a repeated start signal, i.e., a start signal which follows another start signal, is detected. This simpler implementation is suitable when an evaluation of a repeated start state does not require the signaling of a brief interruption of the data traffic on I2C bus 105.

What is claimed is:

1. A method for determining a bus state of an I2C bus having a first line SDA and a second line SCL, the method comprising:
providing a first state SP which is assigned to a non-allocated I2C bus;
providing a second state D3 which is assigned to an illegal state;
providing a third state D5 and a fourth state D4, each of which is assigned to a legal transfer;
wherein the following transitions between the states are defined as follows:
from D5 to D4 if SCL=0 and SDA=rising edge;
from D4 to D5 if SCL=0 and SDA=falling edge;
from SP to D5 if SDA=0 and SCL=falling edge;
from D5 to SP if SCL=1 and SDA=rising edge;
from D4 to SP if SCL=1 and SDA=falling edge;
from D3 to SP if SCL=1 and SDA=1; and
from SP to D3 if SDA=1 and SCL=falling edge.

2. The method of claim 1, wherein a start signal of a data transmission on the I2C bus is determinable based on levels or transitions on the lines SCL and SDA only when a transition takes place from first state SP into third state D5.

3. An evaluation circuit for determining a bus state of an I2C bus, comprising:
a first RS flip-flop a;
a second RS flip-flop b;
a third RS flip-flop c, wherein a binary word is coded by levels of the outputs of the RS flip-flops a, b and c, the binary word being assigned to the states of a method as follows: SP: 101, D5: 001, D4: 000, D3: 111; and
a combinational circuit to form the transitions of the method;
wherein the method is for determining the bus state of the I2C bus having a first line SDA and a second line SCL, by performing the following:
providing a first state SP which is assigned to a non-allocated I2C bus;
providing a second state D3 which is assigned to an illegal state;
providing a third state D5 and a fourth state D4, each of which is assigned to a legal transfer;
wherein the following transitions between the states are defined as follows:
from D5 to D4 if SCL=0 and SDA=rising edge;
from D4 to D5 if SCL=0 and SDA=falling edge;
from SP to D5 if SDA=0 and SCL=falling edge;
from D5 to SP if SCL=1 and SDA=rising edge;
from D4 to SP if SCL=1 and SDA=falling edge;
from D3 to SP if SCL=1 and SDA=1; and
from SP to D3 if SDA=1 and SCL=falling edge.

4. The evaluation circuit of claim 3, wherein an inverting output of the first RS flip-flop a is led out to provide a rising edge when a start signal has been detected.

5. The evaluation circuit of claim 3, wherein the output provides a falling edge, when a stop condition or a repeated start condition has been detected.

6. The evaluation circuit of claim 3, wherein the output provides a low level when the I2C bus is idle or an illegal state is present.

7. The evaluation circuit of claim 3, wherein the output provides a high level when a legal data transfer occurs on the I2C bus.
